(19) United States
(12) Patent Application Publication
(10) Pub. No.: US 2006/0043925 A1
(43) Pub. Date: Mar. 2, 2006

(54) Battery cap for a battery cell of a mobile electronic device

(76) Inventor: Jacobus Nicolaas Tuin, Best (NL)

Correspondence Address: BARLEY SNYDER, LLC, 1000 WESTLAKES DRIVE, SUITE 275, BERWYN, PA, 19312, US

(21) Appl. No.: 11/168,799

(22) Filed: Jun. 28, 2005

(30) Foreign Application Priority Data
Jun. 30, 2004 (EP) 04103095.8

(51) Int. Cl. H02J 7/00

(52) U.S. Cl. 320/107

(57) ABSTRACT

To reduce tolerances of alignment member of battery packs and to simplify the manufacturing process a cap is used which provides the mechanical and electrical connection between a battery cell and a mobile electronic device. The cap, separately manufactured and subsequently attached to the battery cell, comprises at least one contact for a detachable electronic connection with the mobile electronic device, and an alignment face for engaging with alignment member of the mobile electronic device to align the contact with respect to a corresponding contact of the mobile electronic device.

### FIELD OF THE INVENTION

The present invention relates to electrical connectors for battery cells and battery packs for mobile electronic devices and in particular to a cap for a battery cell of a mobile electronic device.

### BACKGROUND

Mobile electronic devices such as mobile phones or personal digital assistants (PDA) comprise power supplies which are typically placed in a cavity of the mobile electronic device. Over the last few years, the size of the mobile electronic devices has remarkably decreased while their functionality and the range of applications offered have increased. Considerable efforts have been taken to reduce the power consumption of electronic components used in the mobile electronic devices. On the other hand, further electronic components have been added to improve the versatility of mobile electronic devices. In particular the desire for enlarged displays have led to an increased power supply demand. Although the efficiency of the power supplies has also been improved, the storage capacity desired requires that the power supply has a relative big size and therefore, a considerable portion of the overall volume of the mobile electronic devices is consumed by the power supply.

Typically, a battery pack comprising a rechargeable battery cell is used as a power supply. Since the storage capacity of a rechargeable battery cell typically decreases over prolonged periods of use, the life-span of the battery cell is limited. The battery cell can also fail for other reasons and therefore, an option to replace the battery cell is highly desired. To meet this desire, a battery pack is typically detachably connected with the mobile electronic device to allow its replacement.

The electrical connection between the battery cell and the mobile electronic device is provided by a specially designed connector assembly. One part of the assembly is attached to the battery cell while the other one is attached to the mobile electronic device. Since mobile electronic devices may experience mechanical strain, the battery cell, which is a compact component having a considerable weight, must be securely fixed within the mobile electronic device. In particular the connector assembly provides an electrical connection between the battery cell and the mobile electronic device and could be damaged if the battery cell is not adequately fixed. In addition to that, alignment of the battery cell is required upon insertion of the battery cell to further reduce the risk of accidental damage of the connector assembly. Alignment member molded onto the battery is limited by certain tolerances so that a proper alignment is not ensured.

It is therefore an object of the invention, among other objects, to reduce the risk of damage to the connector assembly and to improve the reliability of the electrical connection. It is a further object of the invention to reduce unwanted tolerances and to simplify the manufacturing process of a battery pack.

### SUMMARY

According to the invention, a cap for a battery cell for a mobile electronic device includes at least one contact for a detachable electronic connection between the battery cell and the mobile electronic device along with a first alignment member for engaging with a respective alignment member of the mobile electronic device to align the contact with respect to a corresponding contact of the mobile electronic device.

The cap provides for an alignment of the contact and for an electrical connection of the battery cell. In the following description, the term “contact” refers both to one and more contacts unless otherwise stated. The first alignment member is aligned with respect to the contact such that upon engaging with its corresponding alignment member of the mobile electronic device, the contact of the cap is aligned with respect to the corresponding contact of the mobile electronic device. The risk of accidental damage of either of the contacts is therefore significantly reduced. Preferably, the contact allows a detachable connection with the mobile electronic device.

The first alignment member can be of various different sizes and shapes and comprise for instance faces, pins, recesses, indentations or depressions. Moreover, the first alignment member can be formed by only one or two separate alignment structures.

By integrating the first alignment member and the contact into a cap, a modular arrangement of a battery pack is provided. The main components of this modular arrangement are the battery cell and the cap. The cap is separately manufactured and subsequently attached to the battery cell. The modular arrangement offers many advantages over a direct attachment of an alignment member and the connector to the battery cell. For instance, alignment members have often been formed directly on the battery cell by hot-melt molding which involves the risk that hot-melt material gets into a connector already attached to the battery cell. Further, structures formed by hot-melt molding exhibit certain tolerances and are therefore only partially suitable as an alignment member. A direct forming of the alignment member on the battery cell further requires that the battery cell must be pre-aligned prior to the molding which further adds some unwanted tolerances. In addition to that, a direct forming of alignment member on the battery cell limits the number of suitable manufacturing process to those which are compatible with the battery cell to avoid damaging of the battery cell.

The invention reduces or even eliminates these drawbacks by integrating the alignment member and the contact into a separate cap. The separately manufactured cap can be formed with a much higher precision than an alignment member directly molded onto the battery cell.

Preferably, the cap comprises a housing. The housing preferably comprises openings to provide access to the contact for the mating contact of the mobile electronic device. Further, the first alignment members are preferably formed by at least one portion of the housing, in particular as integrally formed structures, such as for instance indentations or recesses. Since the housing with its first alignment members is separately formed, any suitable manufacturing process can be used to make the housing regardless of the compatibility of the battery cell with the manufacturing processes. Once the housing has been formed, the contact and the housing are assembled and aligned with each other. This alignment ensures that the contact of the cap will be properly aligned with the mating contact of the mobile electronic device upon insertion.

To ensure proper alignment of the contact with respect to the housing, the contact comprises an alignment member such as an alignment pin. The alignment member of the contact engages with a corresponding alignment member of the housing, which is referred to as third alignment member of the housing. Preferably, the third alignment members are integrally formed with the housing. The assembly of housing and contact thus forms a connector for connecting the battery cell with the mobile device. The connector is therefore an integral part of the battery cap.

Since all critical alignment members are integrated into the housing, all components are aligned with respect to the housing and therefore with respect to each other.

After assembly of the contact and housing, the cap is attached to the battery. To this end, the cap preferably comprises connection members for an electrical and/or mechanical connection between the cap and the battery cell. Preferably, the cap is permanently attached to the battery cell. An option to provide a permanent attachment is for instance a resistance welding of the connection members to respective connection members of the battery cell. Resistance welding provides a durable mechanical and electrical connection.

In a further aspect of the invention, the cap further comprises second alignment members for aligning the cap with respect to the battery cell. Although an alignment of the battery cell with respect to the cap is not as critical as the alignment of the contact, an alignment of cap and battery cell is also desired. Preferably, the second alignment members are formed to allow an engagement with the connection members of the battery cell. The second alignment members are preferably also integrated into and integrally formed with the housing so that the housing comprises all alignment members and aligns the respective components with respect to each other to reduce unwanted tolerances.

The cap further allows an easy integration of additional components, which are required in connection with the utilization of the battery cell as a power supply. For instance, the battery cell must be protected against overheating and overcharging. The respective electronic circuits providing safety and charging functions are preferably integrated into the cap. To facilitate the integration, the cap further comprises a printed circuit board. Preferably, the contact and the respective electronic circuits are attached to the printed circuit board. In addition to that, the connection members are also attached to the printed circuit board, in particular, when they also provide an electrical connection between battery cell and cap. Preferably, each connection member fixes the printed circuit board within the housing.

A further advantage of the invention is that the cap provides a specific interface between a battery cell and different mobile electronic devices. The caps can be tailored to meet specific needs of different mobile electronic devices such that the same type of battery cell can be used for different mobile electronic devices.

All aspects and advantages outlined above with respect to the cap apply mutatis mutandis to the battery pack and are therefore not reiterated here to avoid superfluous repetitions.

### BRIEF DESCRIPTION OF THE DRAWINGS

The invention will now be described in further detail with reference to the accompanying drawings of which:

FIG. 1 is a perspective view of a cap without a housing attached to a battery cell;

FIG. 2 is a perspective view of a printed circuit board of a cap;

FIGS. 3 and 4 are perspective views showing front faces of a battery cell with connection members;

FIG. 5 is an exploded perspective view of a battery pack comprising a battery cell and a cap;

FIGS. 6 and 7 are perspective views from the rear of a cap;

FIG. 8 is a perspective front view of a housing;

FIG. 9 is a perspective view of a cap with assembled contacts and connection members for connecting the battery cell;

FIG. 10 is a perspective view of three single contacts of a different embodiment;

FIG. 11 is a perspective view of the contacts of FIG. 10 assembled into a housing; and

FIG. 12 is a perspective view of a battery back.

### DETAILED DESCRIPTION OF THE EMBODIMENT(S)

Reference will now be made in detail to embodiments of the invention, examples of which are illustrated in the drawings. Each example is provided by way of explanation of the invention, and is not meant as a limitation of the invention. For example, features illustrated or described as part of one embodiment can be used on or in conjunction with other embodiments to yield yet a further embodiment. It is intended that the present invention includes such modifications and variations.

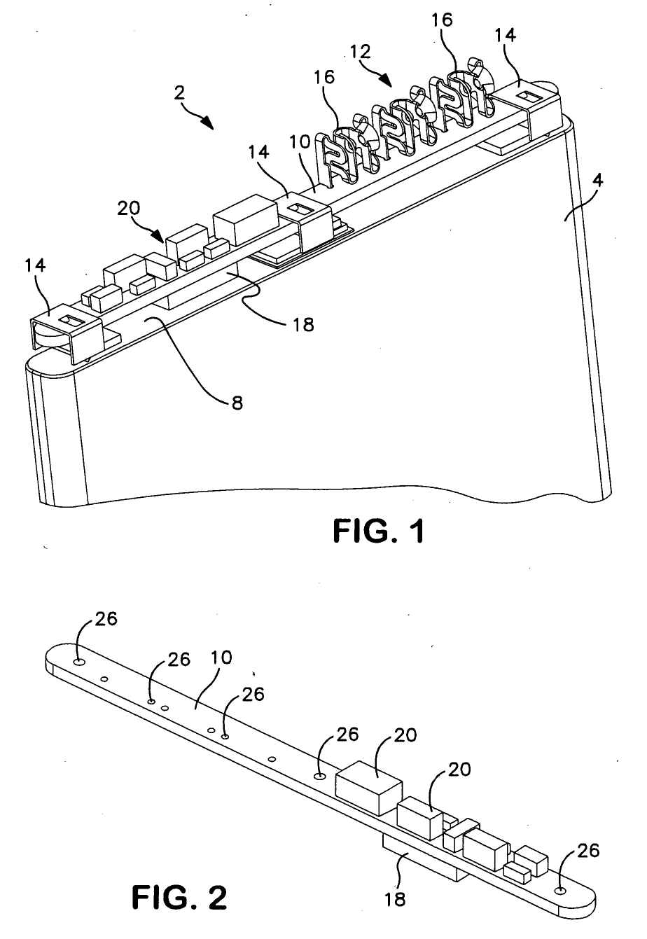

FIG. 1 shows a cap 2 without a housing attached to a battery cell 4. In this particular embodiment, the battery cell 4 is for a mobile phone and has a plate-like body with a thickness of, for instance, about 3 mm. Connection members 6 are formed on a front face 8 of the battery cell 4, to which the cap 2 is attached. The connection members 6 of the battery cell 4 also provide for an electrical connection with the cap 2.

The cap 2 comprises a printed circuit board 10, a connector 12 and welding brackets 14. The connector 12 comprises, in this particular embodiment, separate single contacts 16, each of which is for engaging with a respective contact of a connector attached to the mobile phone. The contacts 16 are soldered to the printed circuit board 10 by manual or automated soldering. In comparison to reflow soldering, the thermal strain occurring during manual and automated soldering is lower. Therefore, cheaper plastic material can be used.

A plurality of electronic components are further soldered to the printed circuit board 10 such as a circuit breaker 18 and a controller 20 for controlling the recharging of the battery cell 4.

Typically, the voltage applied to charge the battery cell 4 is controlled by the charging controller 20. The charging controller 20 terminates the charging when the battery cell 4 is fully charged or disconnects the battery cell 4 when the voltage applied exceeds a given limit. The circuit breaker 18 disconnects the battery cell 4 from the mobile phone if certain critical parameters are exceeded such as the temperature of the battery cell 4.

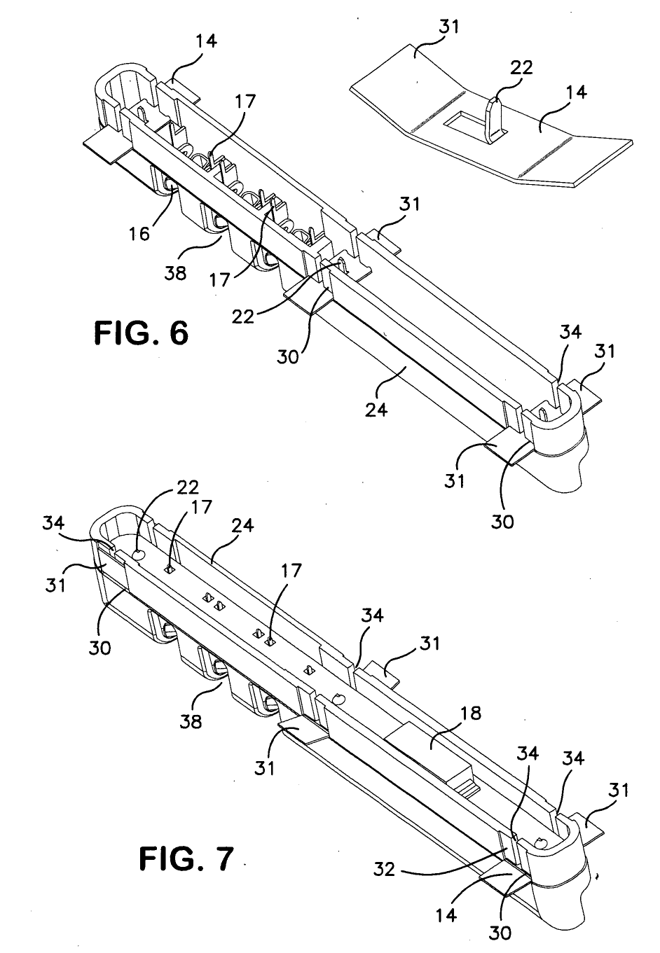

The connection members 6 are formed in this particular embodiment by U-shaped welding brackets 14, each of which comprises a solder leg 22 shown in FIG. 6 for soldering the welding brackets 14 to the printed circuit board 10. The legs 22 of the welding brackets 14 are resistance welded to connection members 6 of the battery cell 4. Besides attaching the cap 2 to the battery cell 4, the welding brackets 14 also fix the printed circuit board 10 to a housing 24 shown for instance in FIG. 7.

FIG. 2 gives a more detailed view of the printed circuit board 10 with soldered controller 20 and circuit breaker 18. Openings 26 are provided for soldering the contacts 16 and the welding brackets 14.

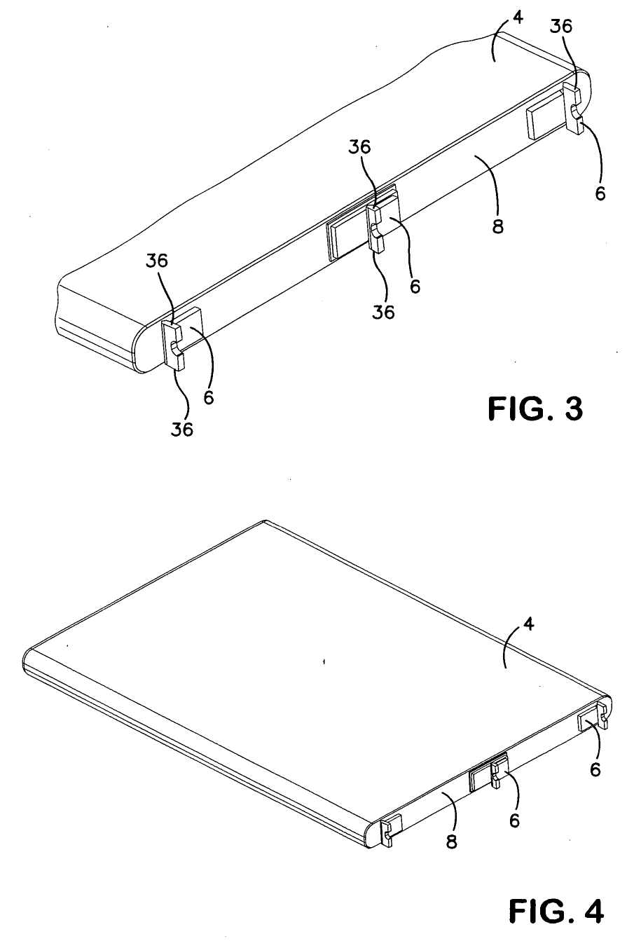

With reference to FIGS. 3 and 4, the battery cell 4 is described in more detail. On front face 8, three connection members 6 are arranged to provide for a mechanical and electrical connection between the battery cell 4 and the cap 2. The outer connection members 6 are directly attached to the housing of the battery cell 4 while the middle connection member 6 is electrically insulated with respect to the housing. In this particular embodiment, each L-shaped connection member 6 is resistance welded to the battery cell 4 on one of its two legs. The other legs project from the front face 8. The size and shape of the connection members are not restricted to the particular embodiment shown here.

The battery cell 4 is typically very thin so as to be insertable into a mobile phone. Typical values for the thickness of the battery cell 4 are 3 mm, 4.7 mm and 5.7 mm. The length of the battery cell 4 with the cap attached can be, for instance, about 54 mm.

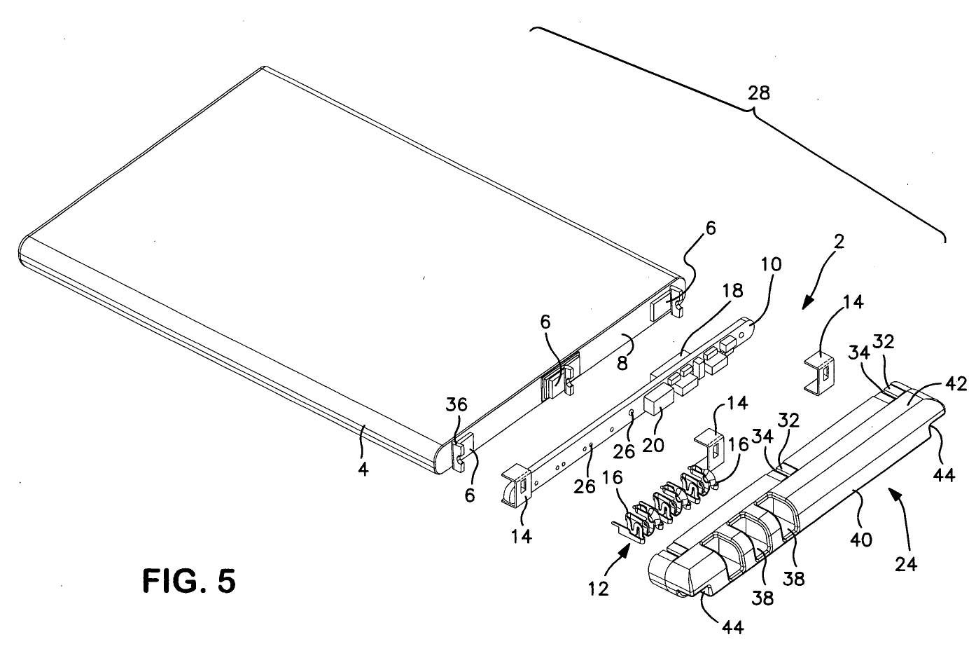

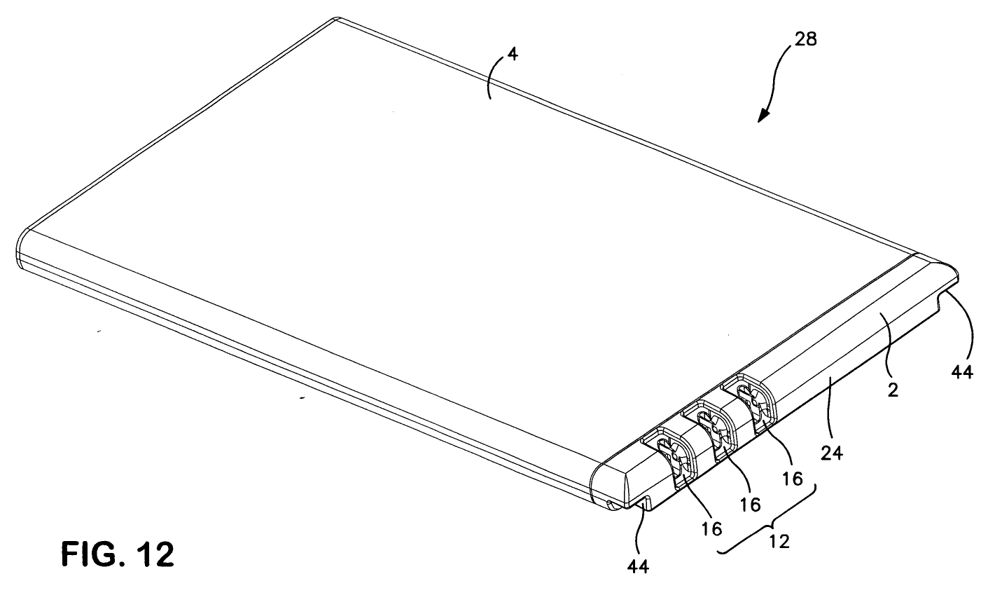

FIGS. 5 and 12 show a battery pack 28 comprising a cap 2 and a battery cell 4. A more detailed illustration of the arrangement of the welding brackets is also shown in FIGS. 6 and 7. The welding brackets 14 extend through slots 30 running parallel to a length of the housing 24. The portions 31 of the welding brackets 14 projecting from the outer lateral surface of the housing 24 are rearwardly bent and are accommodated in recesses 32 arranged on outer lateral surfaces of the housing 24. The thickness of the welding brackets, which are preferably metal brackets suitable to be resistance welded, and the depth of the recesses 32 are adjusted such that the outer surfaces of the welding brackets 14 are substantially coplanar with surrounding portions of the outer lateral surface of the housing 24.

In order to assemble the cap 2, the welding brackets 14 are inserted into the housing 24 by pushing them through the respective slots 30 of the housing with their solder legs 22 projecting in a backward direction. The slots 30 provide a tight fit of the welding brackets 14. The contacts 16 are inserted into the housing 24 and aligned by third alignment member (not shown). In this embodiment, the contacts 16 are clamped between vertically extending internal walls (not shown) of the housing, which form here the third alignment member. In a next step, the printed circuit board 10 is placed into the housing 24 from its rear open end such that the solder legs 22 of the welding brackets 14 and the solder legs 17 of the contacts 16 pass through the openings 26. Preferably, circuit breaker 18 and controller 20 are soldered to the printed circuit board 10 prior of its insertion into the housing 24. The printed circuit board 10 is aligned with respect to the housing 24 by the welding brackets 14 fitted in the slots 30.

After insertion of the printed circuit board 10, the welding brackets 14 and the contacts 16 are soldered to fix the printed circuit board 10 within the housing 24.

To align the housing 24 with the battery cell 4, alignment slots 34, which form here the second alignment member and which run perpendicular to the length of the housing 24, are formed on the rear portion of housing 24. Three pairs of slots 34 are arranged to correspond with the positions of the connection members 6 on the battery cell 4 such that each connection member 6 can simultaneously rest in both slots 34 of a pair. In each recess 32 a slot 34 is arranged so that opposite abutting faces 36 of each connection member 6 are in contact or close to an inner surface of a leg of the respective welding bracket 14. The connection between the welding brackets 14 and the connection members 6 is formed along these abutting faces by resistance welding. To this end, the preassembled cap 2 is put on the front face 8 of the battery cell 4 such that the connection members 6 are inserted into the alignment slots 34, and such that the rearwardly bent legs of the welding brackets can subsequently be welded to the connection members 6 along their abutting faces 36 to provide a permanent and stable mechanical and electrical connection. Upon insertion, the cap 2 is aligned with respect to the battery cell 4 due to the engagement of the connection members 6 with the alignment slots 34.

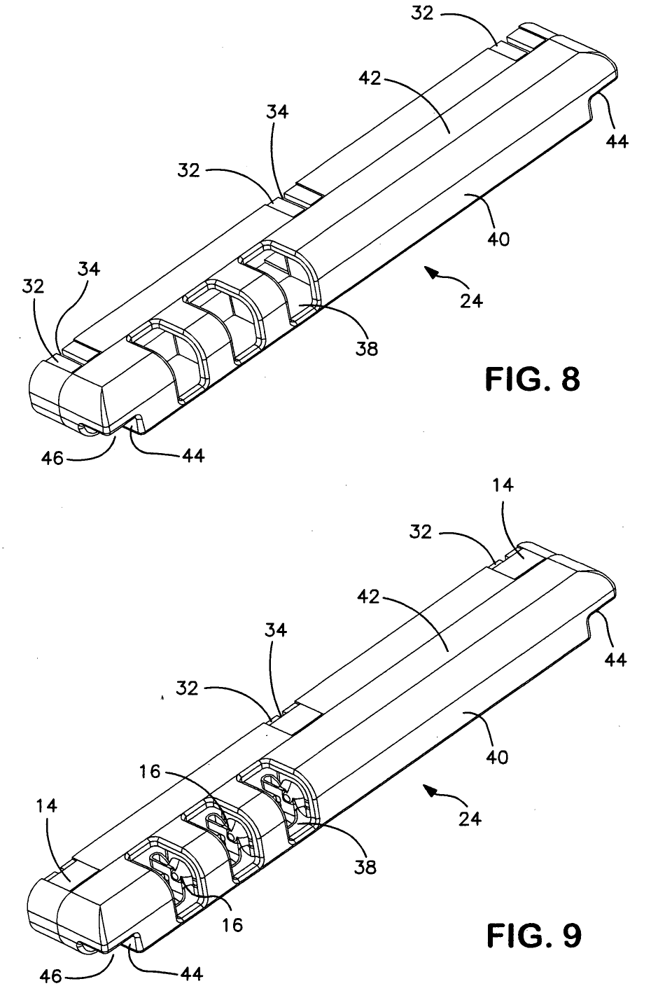

FIGS. 8 and 9 show a front view of the housing 24. Three openings 38 asymmetrically arranged along the length of the housing 24 are formed on the front side of the housing 24 to provide access to each of the contacts 16 of connector 12. Each of the openings 38 runs from the front surface 40 to a lateral surface 42 of the housing 24 to facilitate the insertion of a contact of a mating connector. Since the battery pack 28 is placed into a cavity of the mobile phone, the openings 38 and the contacts 16 allow the battery pack 28 to be easily inserted into the mobile phone without damaging the contacts of each connector.

For aligning the battery pack 28 within the mobile phone, alignment faces 44 are provided on outer edges of the housing 24. The alignment faces 44 are formed by the side surfaces of indentations 46 provided on corners of the housing 24. The alignment faces 44 run parallel to the length of the battery cell 4. Other side surfaces of the indentations 46 run perpendicular to the length of the battery cell and serve as stop surfaces to restrict a lateral movement of the battery pack when placed into the mobile phone.

Due to the engagement of the alignment faces 44 with corresponding alignment member of the mobile phone and the alignment of the connector 12 with respect to the alignment faces 44, the connector 12 is aligned with respect to the connector of the mobile phone.

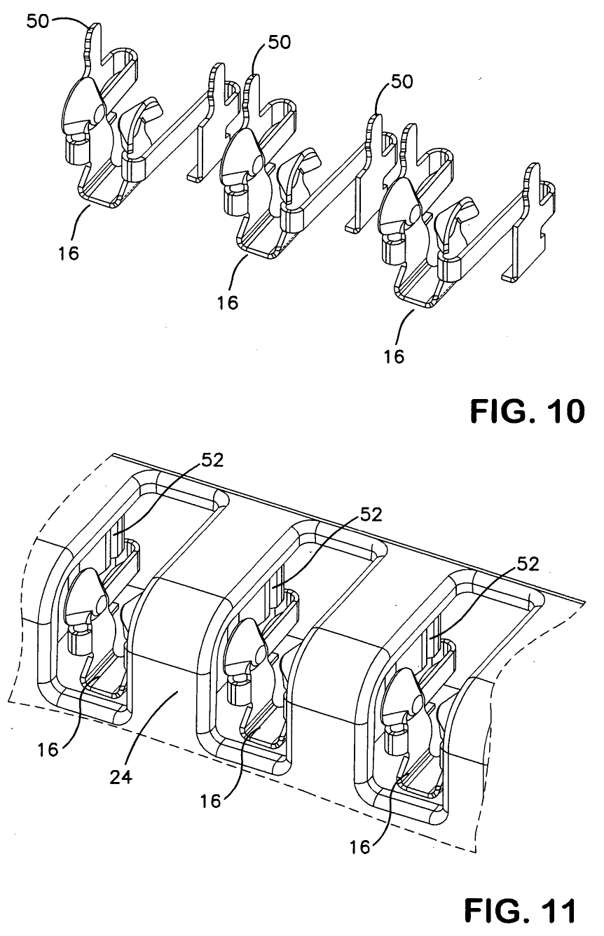

The alignment of the contacts 16 with respect to the housing 24 is described in more detail in conjunction with FIGS. 10 and 11. FIG. 11 shows three contacts 16 of a different embodiment of the invention comprising a different type of contacts. Each alternate contact 16 has two alignment pins 50 that engage corresponding alignment slots 52 of the housing 24. Upon assembly, the alignment pins 50 are inserted into the alignment slots 52 and thereby align the alternate contacts 16 with respect to the housing 24.

The present invention has been described by way of example in connection with the above embodiments and allows a reduction of tolerances involved with the manufacturing of known battery packs and simplifies the manufacturing process. This improvement is achieved by integrating alignment members and the battery connector into a cap and, preferably, into a housing of the cap, which is separately manufactured. Since the alignment member and the battery connector are in the same part, unwanted tolerances, which are connected with the conventional molding processes for forming alignment member directly on the battery cell, are reduced. The cap further allows the integration of further components required for the utilization of the battery cell such as a circuit breaker and a charging controller. The cap is attached to the battery cell by connection members such as welding brackets, which are resistance welded to the battery cell to provide a strong and durable connection. The separate cap does not significantly add to the overall size of a battery pack.

In addition to the inventive cap described so far, a further cap can be attached to a rear face of the battery cell to adjust the overall length of the battery pack for specific needs of different mobile electronic devices. This further or end cap reduces clearances or tolerances between the battery pack and the interior of the respective mobile electronic device such that the inserted battery pack has a good fit in the respective mobile electronic device.

What is claimed is:

1. A cap for a battery cell comprising:
a housing;
at least one contact for a detachable electrical connection between the battery cell and a mobile electronic device; and
an alignment face located within an indentation formed on an outer-edge of the housing for engaging with a respective alignment member of the mobile electronic device to align the contact with respect to a corresponding contact of the mobile electronic device.

2. The cap according to claim 2, further comprising recesses formed along an outer surface of the housing.

3. The cap according to claim 2, further comprising slots formed along the outer surface in the vicinity of the recesses.

4. The cap according to claim 3, further comprising welding brackets being secured in the slots.

5. The cap according claim 4, further comprising a printed circuit board to which the contact is connected.

6. The cap according to claim 5, wherein the welding brackets are attached to the printed circuit board.

7. The cap according to claim 6, further comprising an alignment slot for aligning the cap with respect to the battery cell.

8. The cap according to claim 7, wherein the alignment slot receives a mounting bracket of the battery cell.

9. The cap according to claim 8, wherein the mounting bracket is welded to the welding bracket for an electrical and/or mechanical connection of the cap and the battery cell.

10. The cap according to claim 9, further comprising a second alignment slot for engaging with respective alignment member of the contact.
